(19) United States
(12) Patent Application Publication
(10) Pub. No.: US 2011/0112943 A1
(43) Pub. Date: May 12, 2011

(54) LOCATION-BASED MOBILE WORKFORCE MANAGEMENT SYSTEM

(76) Inventors: Jay B. Dietz, Naperville, IL (US); Stephen L. Gipple, Davenport, IA (US); Patrick J. Simmons, Palatine, IL (US); Eugene Bilenko, Davenport, IA (US); Gerald A. Cox, Coal Valley, IL (US)

(21) Appl. No.: 12/614,881

(22) Filed: Nov. 9, 2009

(51) Int. Cl. G06Q 10/00

(52) U.S. Cl. 705/32; 705/1.1

(57) ABSTRACT

A location-based mobile workforce management system includes a branch reporting tool (BRT) module, a maintenance and acquisition planning (MAP) module and a safety locator module operatively coupled together and delivered via a web server for access by a plurality of wireless hand-held devices respectively associated with a plurality of service technicians in a maintenance and repair organization. The hand-held devices are configured to supply time-based location readings to a locator service, which in turn supplies those readings to the safety locator module. The central system implements an automated method for collecting travel time to a work site, time spent on-site and travel time from the work site to the next work site and calculating paid time for the technicians as well as generating portal-to-portal billed time invoices for billing customers. Among other features, the safety locator verifies technician travel time.

### BACKGROUND OF THE INVENTION

a. Field of the Invention

The invention relates generally to a management system for a workforce, and more particularly to a location-based mobile workforce management system.

b. Background Art

In an industry where equipment routinely needs to be serviced with on-site repairs and maintenance, the management of service technicians can be a very cumbersome task. Managing the various skill sets of the technicians, along with individual workloads can present a very complex optimization problem. Additionally, goals such as reducing commuting time and maximizing both individual and team productivity can make the problem significantly more complex. While this job assignment problem may be complex in itself, the realities of the service industry include many other problems that must be addressed concurrently.

The distributed and remote nature of the on-site service industry creates a need for management to be aware of a technician's real-time location for the purpose of personal accountability and customer responsiveness. Additionally, for client relation concerns, as well as for billing and payroll calculations, it is preferable for management to have near real-time knowledge of job completion status and total technician time spent at each location.

Traditional billing methods have relied on technicians reporting their time strictly on paper time tickets submitted to each branch office. These paper tickets then required a data processing department to enter the time so that customers could be accurately billed, and so that each technician could be paid for their time worked.

U.S. Pat. No. 7,069,333 to Morris disclose a basic wireless system for managing field service personnel, which includes a basic time sheet review mechanism; however, Morris does not disclose any specifics about how time is entered or how to accommodate travel time (e.g., for technician travel). Accordingly, inaccuracies and inefficiencies are still possible with the system of Morris.

There is therefore a need for a mobile workforce management system that minimizes or eliminates one or more of the problems set forth above.

### BRIEF SUMMARY OF THE INVENTION

The present disclosure describes systems and method for operating a location- based mobile workforce management system. The embodiments described herein improve the efficiency of a mobile workforce, particularly in the field of maintenance and repair services. In addition, the embodiments described herein improve the accuracy of time recorded by mobile service technicians, particularly travel time to and from a work site, as well as enhancing technician accountability. Not only do the embodiments described herein result in more accurate calculation of paid hours for the service technicians, but also results in more accurate invoices provided to the customers.

Another advantage is the ability to implement certain contract terms between a maintenance and repair organization and its customers, such as for example “portal to portal” billing where the customer is billed for technician travel time to the job site as well as the travel time from the current job site to the next job site. In one embodiment, for “portal to portal” billing, a method involves determining a travel-to time indicative of the time spent by a technician travelling from a previous work site to the current work site. The travel-to time is calculated by the system using the previous-site departure time and the current-site arrival time, both as captured by a wireless hand-held device associated with the service technician. The method further involves determining the on-site time indicative of the time spent by the technician working at the current work site. The system uses the current-site arrival time and the current-site departure time, both as captured by the hand-held wireless device. The method further involves selectively calculating the travel-from time for the technician to travel from the current work site to the next, successor work site, based on at least the respective locations of the current and next (successor) work sites. Finally, the system is configured to calculate the total chargeable time based on at least the travel-to time, the on-site time and the travel-from time.

The method improves accuracy by suggesting default values for the various time parameters noted above to be equal to the current time/date time, making accurate entry effortless (e.g., when the technician arrives at the work site, his hand-held device defaults the “arrival” time to the current date/time). In addition, to account for the possibility of justifiable adjustments (e.g., when a technician takes non-paid lunch time during travel between sites), the method is configured to allow the technician to reject the suggested default value, and make adjustments and then accept the adjusted, new time/date. Further flexibility is provided, for example, by selectively omitting travel-to time in paid time calculations for the first service order of the day. Moreover, the method may also selectively omit the travel-from time in the calculation as well, for example, for service orders other than 100% billable service orders or when no “next job” exists.

A corresponding system is also presented.

These and other benefits, features, and capabilities are provided according to the structures, systems, and methods depicted, described and claimed herein.

### BRIEF DESCRIPTION OF THE DRAWINGS

FIG. 1 is a block diagram of an embodiment of a workforce management system.

FIG. 2 is a block diagram showing, in greater detail, several features of the workforce management system of FIG. 1.

FIG. 3 is a block diagram showing an overview of the interface provided by the branch reporting tool module of the system of FIG. 2.

FIGS. 4-5 are device displays of main menu and “set destination” screens produced on a display screen of the hand-held device of FIG. 1.

FIG. 6 is the device display after a new service order has been selected by a technician, which changes the status of the service order to an “In Transit to:” status.

FIG. 7 is the device display after the technician has selected the “Arrive” option from the main menu of FIG. 6, indicating to the system of FIG. 1 his arrival at the work site.

FIG. 8 is the device display after the technician has confirmed an arrival time (time-stamp) at the current work site, showing a prompt for paid travel time to the site.

FIG. 9 is the device display after the technician has selected the “Change Destination” menu option of FIG. 6.

FIG. 10 is the device display after the technician has selected a “Shop Location” menu option from the “Change Destination” screen of FIG. 9.

FIG. 11 is the device display after the technician has selected a shop location from the menu options of FIG. 10, which device display showing both the primary location associated with the service order and the secondary, shop location where the technician will actually work.

FIG. 12 is a series of device displays, progressing from an initial “Working At” screen for a callout, reflecting the status of the service order has changed to “Working At:” after the technician's arrival, through subsequent device displays after the technician selects the “LEAVE” menu option.

FIG. 13 is the same device display as FIG. 12 except that it reflects the service order corresponds to a preventative maintenance (PM) service visit rather than a callout.

FIGS. 14-16 are a series of screen displays as shown on the hand-held device for a technician going “off duty” and going back “on duty”.

FIG. 17 is a flow chart diagram showing, in greater detail, the method for time ticket entry shown in block form in FIG. 3.

FIG. 18 is the device display now showing a prompt to capture a work site departure (“Leave”) time-stamp.

FIGS. 19-22 are a series of device displays showing prompts to capture billing status, company vehicle miles and barcode information from the technician for generating a time ticket.

FIG. 23 is the device display now showing, in recap fashion, a summary of the time ticket created via the method of FIG. 17.

FIG. 24 is screen display of a safety locator module interface, showing time-stamped location data organized by segments of time and capable of being plotted on a corresponding map.

### DETAILED DESCRIPTION OF THE INVENTION

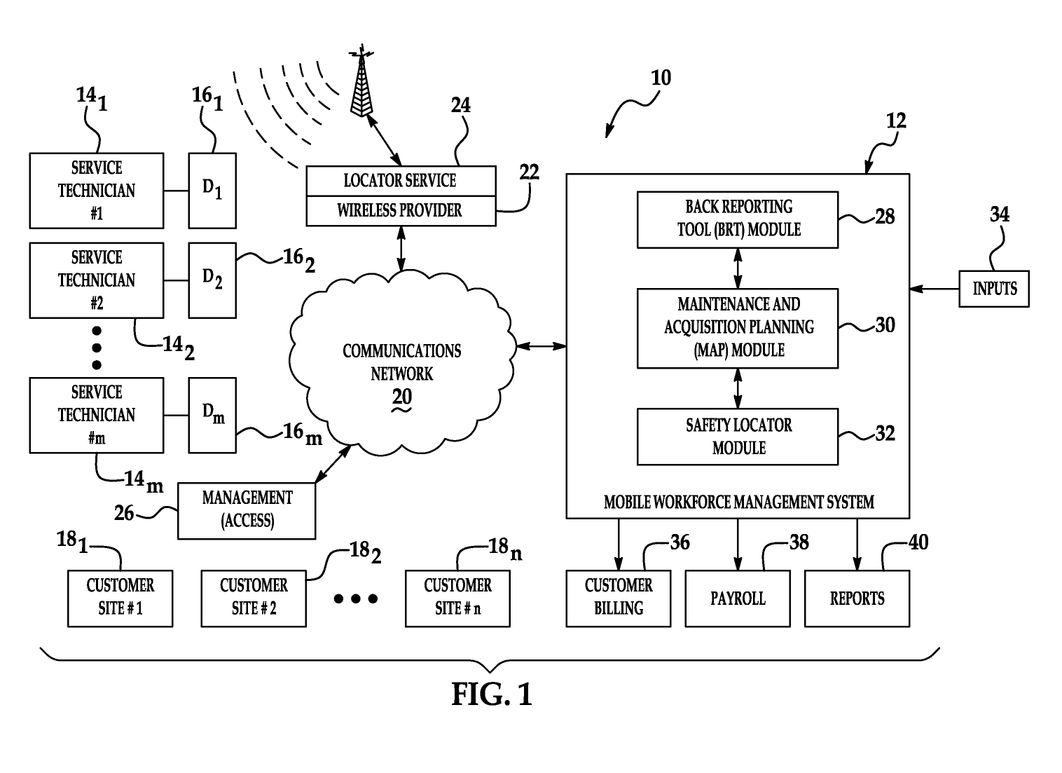

Referring now to the drawings wherein like reference numerals refer to identical components in the various views, FIG. 1 is a block diagram showing an overall layout 10 of a service organization that includes a mobile workforce management system 12. The system 12 is configured generally to optimize the use of a service or field technician labor force while promoting technician accountability, improving accuracy in customer billing, providing real-time job status updates as well as providing tools for managing individual technician workloads.

An organization that may find the system 12 useful will typically have a workforce including a plurality of field service or repair/maintenance technicians 14₁, 14₂, . . . 14ₘ each having a respective wireless hand-held communications device 16₁, 16₂, . . . , 16ₘ associated therewith. The system 12 is configured generally to facilitate services by the technicians at one or more customer work sites 18₁, 18₂, . . . 18ₙ. The system 12 is configured for communications with the technicians by and through a communications network 20, which may be a global communications network, such as the Internet. Moreover, such communications may be further facilitated by and through a wireless service provider 22 to thereby enable communications between the system 12 and the wireless devices 16ᵢ (where i=1 to m). As will be described in greater detail below, the system 12 makes use of time-based location readings obtained from and associated with the devices, as supplied by a locator service 24, which may, but need not, be associated with the wireless service provider. FIG. 1 also shows a management block 26, which represents one or more management personnel affiliated with the organization and accessing the system 12 for reviewing reports and the like.

The system 12, in the illustrated embodiment, comprises three main functional modules: (1) a branch reporting tool (or sometimes referred to as a back reporting tool) module 28 (“BRT”), (2) a maintenance and acquisition planning module 30 (“MAP”); and (3) a safety locator module 32.

General description of system. In general, the BRT module 28 is configured to provide a front-end interface for both management and service field technicians (e.g., for the technicians via the hand-held devices) so as to allow interaction with the mobile workforce management system 12. In one embodiment, the interface generated by the BRT module 28 is rendered as a web site that field technicians 14 can access (using web browsers on the hand-held devices) to view outstanding service orders. At the system level, the BRT module is configured to receive (i.e., from the MAP module 30) data representative of a technician's job queue (i.e., list of suggested, next work assignments/destinations), and transmits such information to the hand-held devices for display. Once the technician selects the next destination, he or she will review the selection details, and confirm the ETA for that next site. After the technician arrives at a service location, he or she can then access the BRT interface (e.g., through a web server) to change the status of the service order to reflect that he/she is working at the job site. When leaving the site, the technician may again access the BRT interface through the web server to further change the job status to reflect completion of the job, prepare a description of work and time ticket, or alternatively indicate the need for additional service. Time associated with the service order, including time travelling to the work site, on-site time as well as time travelling from the work site to the next destination, may all be captured through the BRT interface, as will be described below.

In addition, in one embodiment, the interface of the BRT module 28 allows management access to data entered by each technician 14ₘ in real-time, for review of individual job status, review of billing information, access to payroll information, preparation of labor summaries as well as a variety of other time and cost information.

The MAP module 30 may be configured generally to provide for advanced optimization of a technician's job schedule by taking into consideration factors such as, for example, the customer work site locations, the distance (as well as travel time) to the work sites from the technician's current location, the priority associated with the work at the customers' sites (e.g., a callout for service versus a preventative maintenance visit), the projected length of on-site time to perform the service, a technician's skill set (i.e., suitability for the specific work at a specific site) as well as other factors.

The MAP module 30 may be further configured to balance current or scheduled service demands of various entities requiring technician service against the capacity of individual technicians. By taking into consideration a technician's current location, the BRT module 28, with the analysis performed by the MAP module 30, can present to a technician a list of service orders assigned to that particular technician. Additionally, the MAP module 30 may be configured to have the ability to re-balance workloads if work assignments are unevenly distributed among technicians.

Once the MAP system 30 knows the necessary maintenance tasks (both callouts and preventative maintenance service visits), as well as the location of each service visit, it can then take into account each technician's individual requirements in an optimization application included with the MAP module 30 to perform the above described optimization.

In one embodiment, the MAP module 30 resolves street locations (i.e., corresponding to customer sites) and routes into geo-coordinates using a commercially available mapping software, such as, for example only, Microsoft's MapPoint, to facilitate the MAP module in performing the work assignment function described herein. For clarity, while the MapPoint program, in an embodiment, is used for geo-coding and distance calculations, the optimizations described herein performed by the MAP module 28 for developing a list of assigned service calls preferably do not use MapPoint and are performed according to methodology described elsewhere herein.

The safety locator module 32 is configured generally to identify a technician's real-time location (by virtue of the location of the technician's wireless hand-held device), which enables a variety of location-based functions, such as routing and suggestion of next work sites. Another exemplary use may be to locate a technician when the technician has encountered trouble reaching his or her desired job site, possibly due to a car accident or vehicle engine trouble. In another use, location information is also used in case of emergency (i.e., Safety Alert). Still another exemplary use may be to maintain accountability of technicians 10 by using the time-stamped location readings associated with each technician, which are available in the safety locator module, to verify travel time, on-site time and the like.

For example, in one embodiment, the safety locator 32 may be used to generate a location deviation report. The safety locator module 32 is configured to compare technician route and job site locations, as determined by the MAP module 30 and the BRT module 28, with the actual time-stamped location readings. Once the scheduled route and locations are known, as well as the actual technician position, the safety locator module 32 is configured to calculate deviations from that which are expected or planned. The deviations can be compared against predetermined thresholds to determine whether such deviations are acceptable (within normal variation, or otherwise can be explained). For example, if the technician varies from his or her scheduled route, or comes to a complete and prolonged stop while in route to a scheduled job-site, the system 12 may be configured to alert a supervisor.

With continued reference to FIG. 1, the system 12 receives as inputs (shown as input block 34) or otherwise has access to information that includes but is not limited to contractual maintenance agreements (and the parties and terms thereof), regulatory maintenance agreements (and the parties and terms thereof), customer location information (including customer name, address, equipment, applicable maintenance agreements and the like), skill set or experience description of the technicians, the current arrangement of the schedules for the technicians as well as various accounting information, which may be provided to the input block 34 from an accounting system (not shown, e.g., SAP software).

FIG. 1 further shows a customer billing block 36, which may be configured to calculate and generate customer invoices based on, for example, a Description of Work (DOW) created by the technicians through interaction with the system 12 using their wireless device. FIG. 1 further shows a payroll block 38, which may be configured to calculate and generate a payroll check or other form of payment to a technician based on the information obtained from the system 12. FIG. 1 also shows a report generation block 40, which may be configured to generate management reports concerning various aspects of the work performed by the technicians.

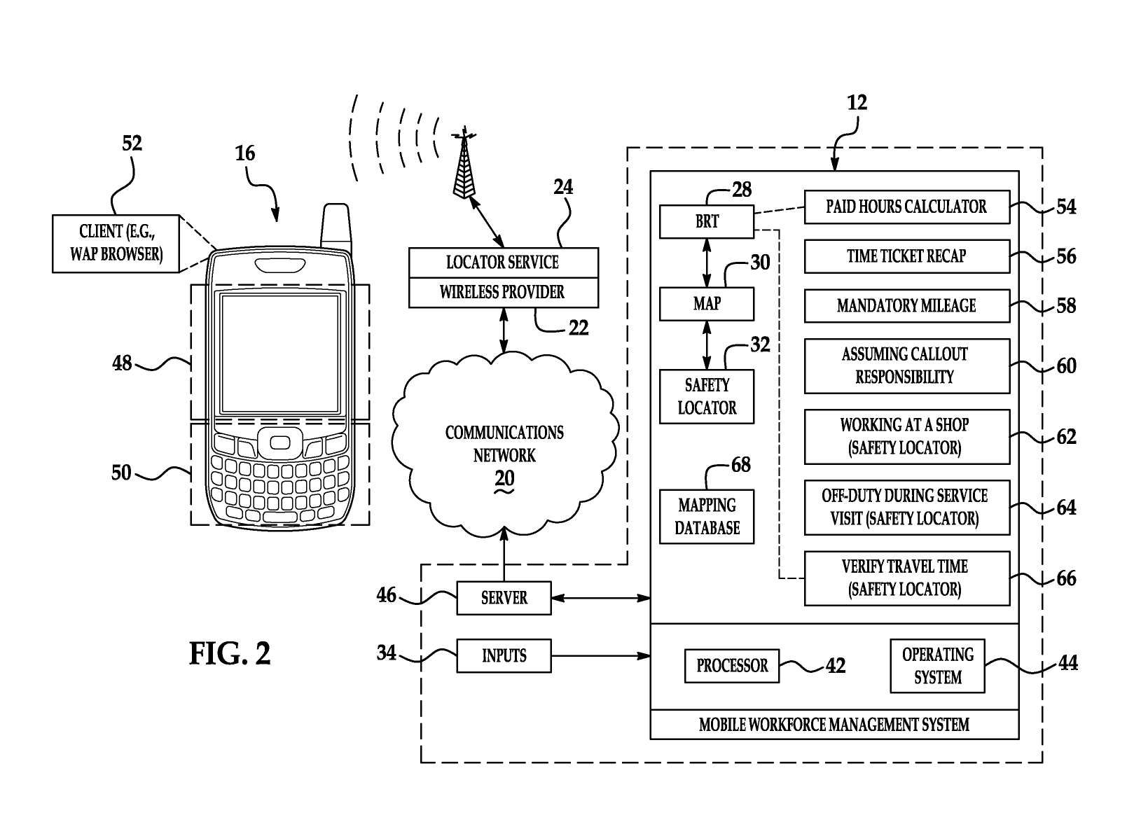

FIG. 2 is a block and diagrammatic view of the layout 10, showing in greater detail the system 12 and the wireless hand-held device 16. The system 12 may be implemented via programming of a conventional general purpose computing platform to form a special purpose machine, which is illustrated in FIG. 2 by the inclusion of a processor block 42 and an operating system block 44 on which the higher level functional blocks may execute. It should be understood that conventional computing platforms on which the system 12 executes may include other features not shown, such as conventional memory arrangements (e.g., random access memory, read-only memory, hard-disk magnetic memory and other types of memory storage), input/output mechanisms (e.g., displays, keyboard, mouse or the like), and communication interface(s).

Embodiments may be computer-implemented based on a client-server model. FIG. 2 shows an internet web server 46 intermediate the system 12 and the communications network 20. The server 46 is configured to facilitate web-based remote access by the technician's using theirs hand-held devices to the BRT interface of system 12. The server 46 may comprise conventional and commercially available apparatus and software.

The device 16 is configured for remote access to the system 12, and in this regard, may include a display 48, an input interface 50 such as a keypad, as well as a client remote access program 52, such as a Wireless Markup Language (WML)-compliant web browser or the like suitable for execution on a hand-held device such as device 16. In addition, the device 16 is preferably configured for compatibility with location-based services, either through GPS functionality or via other known approaches. The device 16 may also include still further functionality, such as various voice and data communications capability, all as known in the art. The device 16 may comprise conventional and commercially available apparatus, such as, for example only cellular telephone model nos. i58sr, i355 and i365, manufactured by Motorola, Schaumburg, Ill., USA.

The wireless service provider block 22 shown in FIG. 2 is configured to carry data traffic between the system 12 and the plurality of hand-held devices 16₁, 16₂, . . . , 16ₘ. Conventional and commercially available wireless data and voice services may be used.

The locator service block 24 is configured to interact with the hand-held devices 16₁, 16₂, . . . , 16ₘ to obtain a time-stamped location reading (e.g., a time-stamped GPS position coordinate) indicative of the location of such hand-held device. In one embodiment, the time-stamped location reading is determined using a GPS receiver integrated into the technician's hand-held device 16 and such reading is transmitted by the locator service block 24 to the safety locator module 32. In another embodiment, the time-stamped location reading may obtained by the locator service block 24 through cell tower triangulation, the cell tower in operation with the hand-held device or other methods now known or hereafter developed. However obtained, the time-stamped location readings may then be provided to the system 12 (i.e., safety locator). Such time-stamped location readings for each hand-held device 16₁, 16₂, . . . , 16ₘ may be provided by the locator service 24 at predetermined time intervals, for example, between about every 8-12 minutes, and preferably about every 10 minutes. The time-stamped location readings received by the system 12 may be recorded in a suitable non-volatile data storage medium for subsequent use in implementing a number of location-based features. In one embodiment, the wireless service provider 22 and the locator service block 24 may be rendered by the same organization, in conjunction with compatible hand-held devices 16₁, 16₂, . . . , 16ₘ. For example only, the wireless service provider NEXTEL, who also offers hand-held devices in connection with its services, further offers such a locator service under the Nextel Mobile Locator Service (MLS) trade designation. It should be understood, however, that the provision of wireless data and voice services (as per block 22) and location-based services (as per block 24) need not be integrated in any manner, and may be provided separately.

Feature Set. The system 12 is configured to implement a number of features for improving efficiency and increasing safety. In this regard, the BRT module 28 includes a number of function blocks including a paid hours calculation block 54, a time ticket recap block 56, a mandatory mileage entry block 58, an callout assumption of responsibility block 60, a working at a shop block 62, an off-duty during service visit block 64 and a verification of travel time block 66. The last three mentioned blocks 62, 64 and 66 involve the time-based location readings derived from the hand-held devices 16₁, 16₂, . . . , 16ₘ and associated with the service technicians 14₁, 14₂, . . . , 14ₘ. The blocks 54 through 66 correspond, in one embodiment, to programmed functionality in accordance with the respective feature descriptions to be set forth in greater detail below.

In addition, the system 12 includes a mapping database 68 of the type configured to provide a travel time between first and second locations when such locations are provided as an input. As incorporated into the larger system, the system 12 provides a list of locations (with callouts or open maintenance orders) and travel times to those locations. In one embodiment, a commercially available product sold under the trade designation MapPoint, by Microsoft, Redmond, Wash., USA, may be used, which is configured to provide as an output not only routing options between locations but provide distance estimates as well as travel time estimates between locations.

The illustrative embodiment involves service and maintenance operations pertaining to elevators and escalators, although it should be clearly understood that this is only one exemplary field of use. After installation of such equipment, it is routine for the purchaser and/or lessees to enter into maintenance agreements with a maintenance organization (which may, although need not be, affiliated with the seller/lessor of the equipment) for the service and maintenance of the equipment. Such service agreements can vary significantly in the terms and conditions for the service including specification of what services and/or parts will be included in the warranty (and for how long post-sale) and may further specify what services (and/or parts), whether in warranty or not, may be considered chargeable to the customer. Such terms may involve the type of service (e.g., preventative maintenance versus equipment that has failed or does not work correctly), the time of day such service would occur (e.g., normal business hours versus night or weekend) as well as many other terms and conditions, limited only the imagination of the contracting parties. Historically, these agreements control in part whether or not the customer would get billed, and if so, for what.

As mentioned above, the terms and conditions of the various service/maintenance agreements for the various customers are stored (i.e., block 34 in FIGS. 1 and 2) and used by the system 12. An example of this input may be where sales staff from an elevator manufacturing company enters the required maintenance schedule for each elevator sold into a database, constituting one of the inputs in input block 34. An example of a maintenance schedule may be, for example, that elevator inspection maintenance occurs on a periodic basis, such as every three months, while a more thorough maintenance occurs on a second, longer periodic basis, such as every six months.

The term callout is used herein and refers to the situation when a customer reports an inoperative or abnormally operating piece of equipment and requests that a service technician be called out to the customer site for inspection and remediation. A callout may be distinguished from a preventative maintenance service visit, which may refer to the situation where the service technician has been scheduled in advance to perform preventative maintenance (PM) on the equipment. Among other differences, a callout is generally of higher priority due at least to the inoperative or abnormally operating equipment. A service order may be created in the system 12 by virtue of either scheduled maintenance of a piece of equipment at a customer work site or by virtue of a customer call requesting service/repair. In either case, the service order may uniquely identify work to be done at a particular customer work site. From the service order, one or more work assignments (“jobs”) may be created on a per technician basis (i.e., a particular task or set of tasks to be performed at a particular work site, related to a service order under which the customer may be billed).

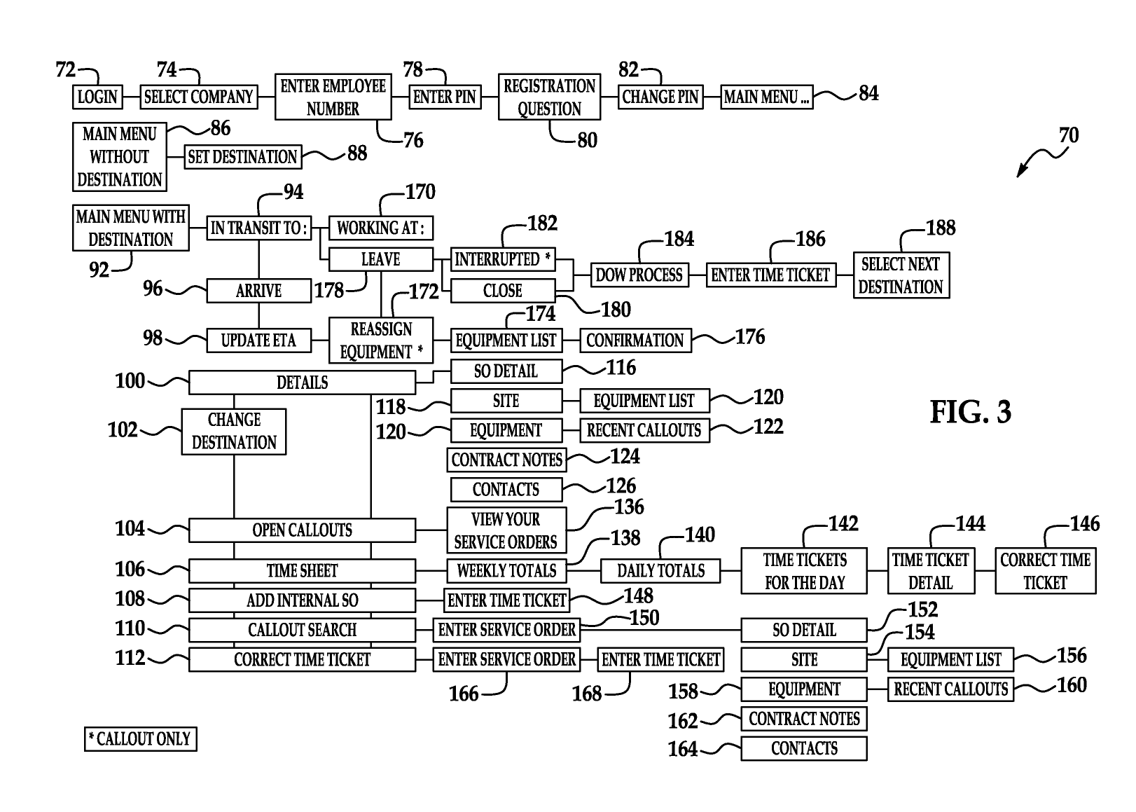

FIG. 3 is a block diagram 70 showing an overview of the interface provided by the BRT module 28. The features mentioned as functional blocks 54 through 66 (FIG. 2) will now be referenced with regard to the diagram 70. It should be understood that while the diagram 70 is structured as a navigational reference from the point of view of a technician, the operation of the BRT module 28 does not necessarily have to be similarly arranged. The diagram 70 will be described in terms of “blocks”, the blocks corresponding to screen displays (or a series of screen displays) presented on the display of the technician's hand-held device. It should be understood that the blocks in FIG. 3 also correspond to the underlying functions performed within and by the BRT module 28.

Blocks 72 through 84 of the diagram 70 involve initial authentication of the service technician and registration of a hand-held device 16 with a specific technician. The authentication function ensures that any person logging in has the proper credentials while the registration function ensures that any information originating with and obtained from that specific hand-held device, such as time-stamped location readings, can be properly associated with a specific technician. In addition, the system 12 and its main components (i.e., BRT module, MAP module and safety locator module) need to know the technician-to-handheld device association.

To initiate access to the system 12, a service technician initially points the browser 52 to a predetermined uniform resource locator (URL) (“web site”). Of course, the URL can be bookmarked to facilitate access in the field. After accessing the predetermined URL, the initial blocks (screens) 72 through 84 are retrieved from the BRT 28 to be presented on the display of the device 16. It should be understood throughout that when a description is made of a screen display on the device (e.g., of a menu with a list of options), that the browser 52 on the hand-held device is simply rendering and displaying the markup language (or other information) being sent by the BRT module 28 through the server 46. In other words, the display changes and flow logic observed at the device display reflects the configuration of the BRT module 28 specifically and more generally the system 12.

With continued reference to FIG. 3, in one embodiment, access to the system 12 using the device 16 may be made only after a user (i.e., a service technician) has been authenticated to the system 12. The authentication procedure starts in block 72 (logon). In block 74, the device 16 displays a prompt seeking selection of a company (i.e., for example, if the technician performs services for more than one company). In blocks 76 and 78, the device 16 displays a prompt to capture a user identification (e.g., an employee number, but could be any preselected user ID) and a password (e.g., the personal identification number—PIN). If the captured employee number and PIN properly authenticate the technician, then the BRT 28 module, in block 80, performs an internal check of its records to determine whether the particular hand-held device 16 is already registered to the technician who just logged in. The BRT module 28 can perform this check through any number of methods known in the art, using an unique identifier associated with the phone and maintaining a table or the like containing the device-user associations. If no previous association can be located, a prompt will be displayed on the device to register the device, after which such device-user (technician) association is stored by the BRT module 28. After registration (if needed), in block 82, the BRT 28 may require the service technician to change a default PIN (i.e., like a default password), and suitable prompts are displayed on the device display. In step 84, the device 16 displays a main menu including a number of technician-selectable menu options. There are two types of main menus: (1) a first main menu that is presented when the technician has not yet selected a “next destination” (i.e., customer work site at which a work assignment will be performed); and (2) a second main menu that is presented to the technician after the next work assignment/next destination has been selected.

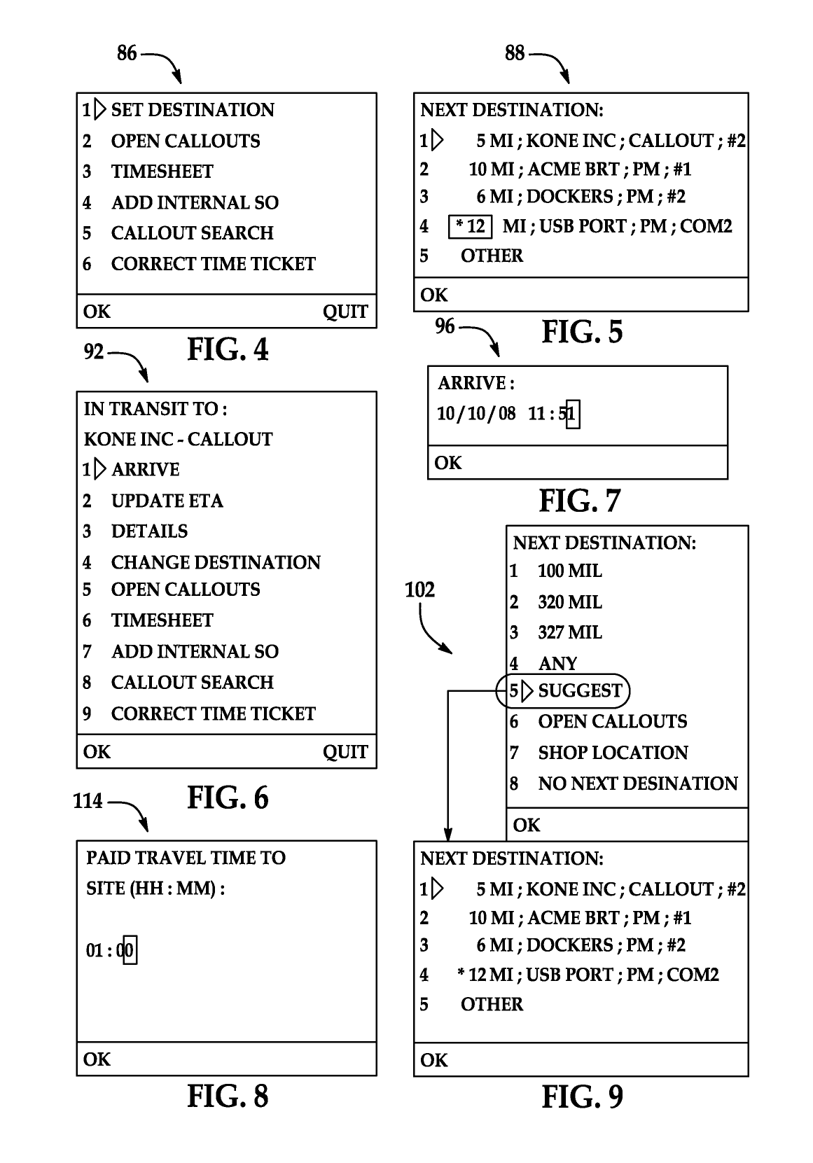

FIGS. 4-5 are device displays of a main menu screen and a “set destination” screen shown on the device 16. The type of main menu shown on the device 16 before a “next destination” is selected by the technician is labeled as block 86 in FIG. 3 and this is also shown in FIG. 4. The technician is prompted to select choice “1” (FIG. 4), which is labeled “Set destination”. The technician may select the “Set destination” through interaction with the device interface (e.g., keypad), although it should be understood that throughout this description, other approaches for selecting an option (e.g., touch screen, clicks and the like) as known in the art, and are contemplated to be within the spirit and scope of the invention.

Once the technician selects the “set destination” menu option, the device 16 shows the “set destination” screen 88 in FIG. 5 (also represented as block 88 in FIG. 3).

As shown in FIG. 5, in one embodiment, the device 16 displays the top five service orders currently assigned to that specific service technician, and which are available for selection. This personalized list of service orders may includes service callouts and preventative maintenance (PM) orders within that service technician's route. It bears emphasizing that the MAP module 30 is configured to generate this personalized (and optimized) list of service orders as a function of many input variables, such as the service technician's current location (i.e., as per the time-stamped location readings obtained from the device 16) and thus distance to any candidate next destination, travel time to any candidate next destination, technician skill set as compared to a service order, service order priority, workload leveling, minimization of overtime and the like.

In the illustrated embodiment, the personalized list of service orders is arranged on the display in order of priority. Priorities may include criteria such as callouts versus preventative maintenance (PM) visits (i.e., callouts generally have higher priority than PM service visits). Each service order may have a plurality of pieces of information associated therewith, some of which are specifically generated for that service technician, and which may not only be used by the MAP module 30 in generating the personalized list to begin, but may also be shown on the device display. This information ma include: (1) driving mileage (i.e., from the current location) where in the illustrative embodiment an asterisk (“*”) indicates that the mileage is estimated; (2) the site name; (3) the service visit type (callout or PM); and (4) the equipment type. Note that the MAP module 30 may also use driving time as a parameter to optimize the listing of the service orders. For example, in FIG. 5, the personalized list has the “Dockers” site at a lower priority than the “Acme” site, even though the “Dockers” site is closer. This ordering is the result of the “Acme” site being a shorter drive time from the current location, notwithstanding the greater physical distance. The technician may select one of the destination sites (service orders) through interaction with the device interface. This selection is sent wirelessly to provider 22 and then to the system 12, where the selection is processed by the BRT module 28. If the selected service order (work assignment) is accepted, an acknowledgement message may be displayed on the device (e.g., “Your update request has been successful”). In addition, the BRT 28 creates a new time ticket for the selected service order. The BRT 28 also stores the current time (i.e., date/time of day) as a departure time from the current location, which may be a customer work site, in which case a “travel to” next work site time may need to be calculated. This is why the BRT module 28 stores the departure time, which, as will be described below, will be referred alternatively as a work site “LEAVE” time.

FIG. 6 is the device display after a new service order (work assignment) has been selected. Once the service order (work assignment) requested by the technician has been accepted by the BRT module 28, the status of the selected service order changes so that the status of the service order is technician “In Transit To:” next location. For this status, the other type of main menu is displayed on the device 16. This second type of main menu is labeled by reference numeral 92 (and is also shown in FIG. 3 as block 92). In the illustrative embodiment, the device 16 displays the now-current status (i.e., “In transit to:” legend being designated as block 94 in FIG. 3). Several selectable menu options are displayed on the device 16, including in order (1) “Arrive”; (2) “Update ETA”; (3) “Details”; (4) “Change Destination”; (5) “Open Callouts”; (6) “Timesheet”; (7) “Add Internal SO”; (8) “Callout Search”; and (9) “Correct Time ticket”, which options respectively correspond to blocks 96, 98, 100, 102, 104, 106, 108, 110 and 112 in FIG. 3.

Thus, as the technician is traveling to the next, selected work site, the status “In transit to:” is prominently displayed on his/her device 16. In addition, as the technician 14 travels to the selected/next work site, the safety locator module 32 acquires, from the locator service 24, and stores, a series of time-stamped location readings. Among other uses, the location readings may at least be used to verify travel-to time.

FIG. 7 is the device display after the technician has selected the “Arrive” option in the main menu of FIG. 6. The screen of FIG. 7 prompts the technician 14 to confirm his/her “Arrive” date/time. The device 16 displays a default value for the “Arrive” time at the current work site as being equal to the current date and time. This field is thus auto-populated with the default value, obtained from either BRT module 28 or the wireless provider network or the device 16 itself, for example. In any case, the default value is displayed on the device 16, but the device 16 is configured so as to allow the technician, via interaction with the interface thereof, to either accept the default value, or alternatively to adjust the default value to a new date/time value. After the arrival time (“ARRIVE”) at the current work site has been captured and stored at the BRT module 28, the BRT module 28 updates the status of the service order from “In transit to:” to “Arrived”. The updated service order status may be indicated on the device display by a header message or the like (e.g., “Working at:” WORK SITE—see, e.g., FIGS. 12 and 13 for examples of this status display). In an alternate embodiment, the arrival may be detected automatically based on the GPS (location) information matching the work site location and the date/time of that match being recorded as the arrival time; however, in a current embodiment, automatic arrival detection is not preferred because the GPS (location) information is only requested every 8-10 minutes, making such location information generally too old to be useful in many instances.

FIG. 8 is a device display 114 shown after the technician 14 has confirmed the arrival time. The screen display 114 shows the prompt “Paid travel time to site (HH:MM)” and the device 16 is configured to allow the technician 14 via interaction with the device interface to either accept the default time, or alternatively to adjust the default to a new time. The default time is automatically generated (e.g., by the BRT module 28) based on the difference between the previous work site departure time (i.e., the previous work site “LEAVE” time-stamp) and the current site arrival time (i.e., the current work site “ARRIVE” time-stamp).

Referring again to FIG. 3, the other menu options available from the “main menu with destination” will now be briefly described. The “Update ETA” block 98 may be selected by the technician 14 to view and edit the callout Estimated Time of Arrival (ETA). If the ETA entered by the technician 14 exceeds performance assurances (i.e., on site requirements, for example, as per customer agreement), then a suitable warning message may be displayed.

The “Details” menu option (block 100), if selected, allows the technician 14 to review the following categories of information about the service order: (1) SO Detail—provides service order (SO) information for the callout (e.g., block 116, FIG. 3—essentially the same information that is displayed when the callout was accepted); (2) Site—provides basic site information (block 118, FIG. 3) and allows the technician 14 to list all of the equipment at the site (block 120, FIG. 3); (3) Equipment—provides details about the equipment (block 120, FIG. 3) and the technician 14 can see a list of recent callouts (block 122, FIG. 3); (4) Contract Notes—provides available contract, location and equipment notes (block 124, FIGS. 3); and (5) Contacts—provides site, contract and callout contact names and telephone numbers (block 126, FIG. 3).

FIG. 9 is the device display if the technician 14 selects the “Change Destination” menu option (block 102, FIG. 3) from the main menu of FIG. 6. This option allows the technician 14 to enter a different service order number to change his/her selected destination. For example, in FIG. 9, selecting the “Suggest” menu option will result in a listing on the device display of the top five service orders assigned to that specific technician.

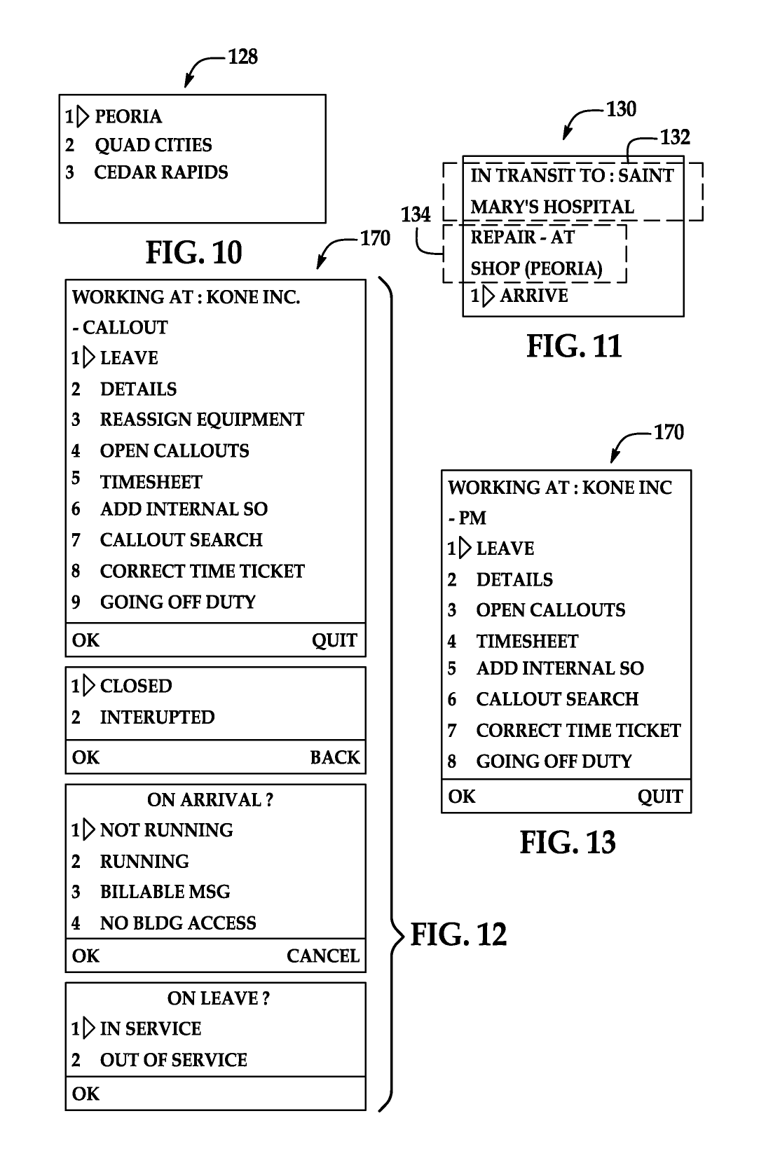

FIG. 10 is the device display when the technician 14 selects the “Shop Location” menu option (see FIG. 9) from the “Change Destination” menu. Selecting a “shop location” is an option that is useful, e.g., when the technician is part of a repair crew and is working at a shop location instead of a customer work site. The technician may be involved with fabrication/assembly of components, or other job preparation best done in a shop. The screen display 128 may list one or more “shop” locations available to the technician 14, which are different from the main work site location associated with the service order.

FIG. 11 is the device display (designated screen display 130) after the technician 14 selects one of the shop locations offered in the list of shop locations in FIG. 10. The screen display has now changed. A first portion 132 of the overall screen display 130 shows the primary work site associated with the service order (“SAINT MARYS HOSPITAL”); however, a second portion 134 (e.g., below the first portion) shows a secondary work site, namely, the shop location selected from the list in FIG. 10. The technician 14 is actually travelling to the shop location and not the primary work site associated with the service order. The safety locator module 32 continues to obtain time-stamped location readings (i.e., originating from the hand-held device) while the technician 14 travels to and arrives at the shop location; however, as will be described below in greater detail, a location deviation report for the technician will not indicate an unexpected deviation so long as the technician is at the shop location because any location deviation will be calculated with respect to the shop location and not the customer work site location. In a prior system that calculated deviation relative to the primary work site when a technician worked at a shop, the calculated deviation could be misinterpreted as the technician not being where he/she was supposed to be.

Referring again to FIG. 3 (and the corresponding “main menu” screen display of FIG. 6), a number of further options will be briefly described. The “Open Callouts” block 104 is configured to display on the device 16 all open callouts that are assigned to that service technician (see block 136). The “Time Sheet” block 106 is configured to allow the technician 14 to review time tickets entered for the current pay period (e.g., weekly recap—block 138). In addition, the block 106 is configured to display a recap for each day (i.e., daily recap—one line per day—block 140) and allow the technician to select a particular day for further review. The block 106 then displays the list of time tickets (i.e., daily detail—block 142) for the selected day and allows the technician 14 to select a particular time ticket from the list for further review (i.e., time ticket detail—block 144). The selected time ticket may or may not be able to edit the time ticket, e.g., if the ticket has already been approved by a supervisor, no further editing can be made by the technician via the device 16. Block 146 is configured to allow editing of the selected ticket. The process of editing a time ticket will be described below, as part of the overall wrap-up of a service visit, but will be the same. The “Add Internal SO” block 108 allows the technician to select an internal service order for entry of time and expenses (e.g., Holiday pay, trial pay, vehicle and travel expense, etc.—see block 148). The “Callout Search” block 110 is configured to allow the technician to search for callouts (block 150) for which the technician is not assigned. Once a service order number is found, the interface allows the technician read-only access to the service order details (see blocks 152 through 164, which correspond to blocks 116 through 126 described above). Finally, the “Correct Time Ticket” block 112 is configured to allow the technician to enter a service order (block 166) number in order to locate a service order record, and then to correct a time ticket within the current pay period (e.g., to add hours or expenses to a service order—block 168).

FIG. 12 is a series of device displays showing a change in service order status to “Working At”, which occurs after the technician indicates arrival at the work site. This change in status is reflected in the “Working At:” legend. The “Working At:” main menu is designated by reference numeral 170. Note that FIG. 12 shows the main menu for a callout while FIG. 13 shows the main menu for a preventative maintenance (PM) service visit. One difference between a callout and a PM visit is that the inoperative or malfunctioning equipment may have been misidentified. In other words, if the technician discovers on arrival that a callout has been assigned to the wrong equipment, the BRT module 28 (through the device 16) provides a mechanism for reassignment, shown in “Reassign Equipment” block 172 (FIG. 3). This is menu option “3” in FIG. 12. Once the technician 14 selects this option, the device display shows a list of equipment recorded as being deployed at the site (block 174, FIG. 3) and further provides the mechanism for the technician to make select different equipment to correct the assignment (block 176, FIG. 3).

A further option shown on the main menu of FIG. 12 (and FIG. 13) is a “LEAVE” option (block 178). There are two reasons the technician 14 may be ready to leave the current work site. First, the technician may be ready to leave because the requested work has been completed. Second, the technician may need to leave because of a need to change personnel, need to obtain a needed but unavailable part, or for other reasons. Accordingly, after the technician has selected the “LEAVE” option on the hand-held device 16, the logic in the BRT module 28 is configured to present on the device display a listing of two options to reflect how the technician wants the status of the service order to be addressed in these two situations: (1) “Closed” (block 180, FIG. 3) and (2) “Interrupted” (block 182, FIG. 3). When either the “Closed” or “Interrupted” option is selected, a series of screens to be presented for collecting information describing the condition of the equipment on the technician's arrival, the condition of the equipment upon leaving as well as prompts to facilitate time backreporting (collectively, the description of work (DOW), block 184, FIG. 3). The “on arrival” and “on leave” screens are shown in the bottom two screens of FIG. 12. Additional screens may be presented on the device 16 that prompt for additional comments concerning the service order/DOW. This information is recorded by the BRT 28 for further use in the system 12. Alternatively, if the technician 14 selects the “Interrputed” option, meaning that additional work is needed, then the service order is not closed out, but rather remains in progress but acquires the status of “Interrupted”. The mechanism for changing the service order's status to interrupted allows a second technician to assume responsibility for the service order by accepting responsibility for continuing and closing the interrupted service order through his hand-held device, and for ultimately closing out such service order, even though the second technician did not initially start work on that service order.

FIG. 13 shows the “Working at” main menu screen for a preventative maintenance (PM) service visit. The series of screens presented on the device display are somewhat different for a PM service visit, due in part to the fact that the equipment is assumed to be in operating condition, and the real information desired is that needed to produce a description of work (DOW) for a customer invoice (if applicable). The series of screens after the technician selects “LEAVE” generates, for example, one or more “pick lists” of tasks performed (e.g., audit, basic, ctrl panel, full load test, lamp & signals, machinery, Hyd Annual Test, Pwr Door Opener, and Test Quote Rem to describe a few). Some tasks, when selected, will spawn additional screens for additional, related information (e.g., selecting the “Add Oil” task will spawn a second screen “Enter Gals Added”). These screens collectively also relate to the DOW process block 184 in FIG. 3.

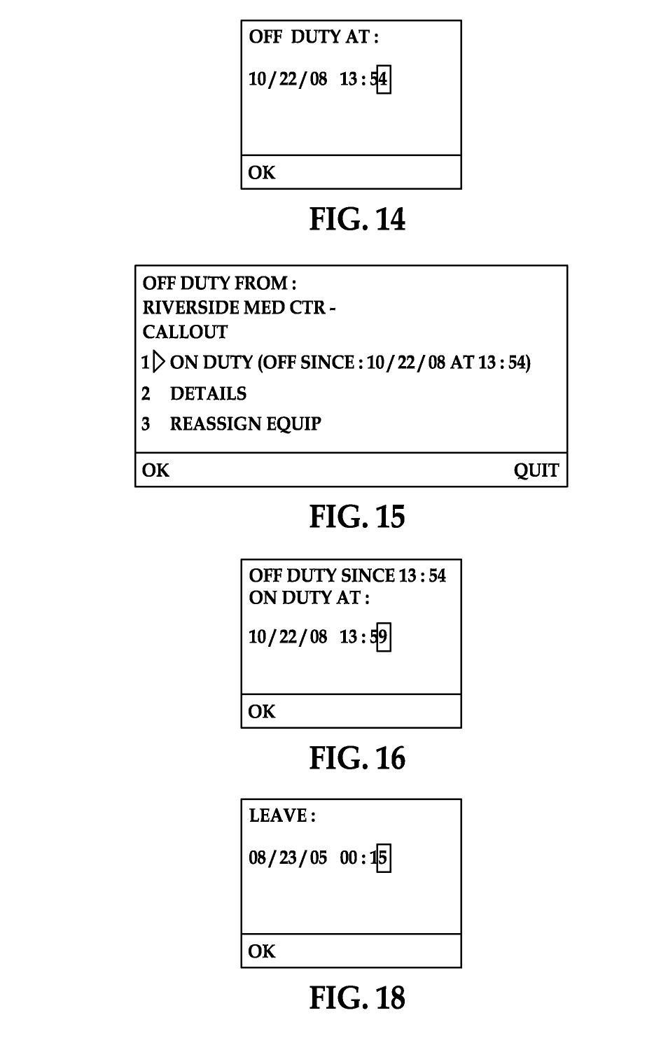

FIGS. 14-16 are a series of screen displays after a technician selects the “Going Off Duty” menu option for the “Working At:” menu, such as shown in FIG. 12 or FIG. 13. The BRT module 28 includes functionality to accommodate a technician temporarily (e.g., with permission) leaving a work site while working on a service order. The BRT module 28 in particular allows the technician to designate a non-paid time period (e.g., a lunch break) during a service visit as “Off Duty” without creating another time ticket. This feature improves the efficiency of the overall operation of the system 12. In addition, the safety locator module 32 is configured to suppress recording of the time-stamped location readings during the time period that the technician is “Off Duty”.

On the “Working at” menu screen (block 170, FIG. 3), the device display provides a menu option selectable by the technician for “Going Off Duty” (e.g., see FIG. 12 or FIG. 13: “Going Off Duty”). In other words, this option, in the illustrative embodiment, becomes visible (or is enabled) once the technician has arrived at the customer work site. Once the technician selects the “Going Off Duty” option, a new screen display is presented on the hand-held device 16, as shown in FIG. 14. The BRT module 28 establishes a default value for the “Going off duty” time that is equal to the current date and time (although the default value may also be provided by the wireless provider network or the device 16 itself, for example,). The default value is displayed on the device 16, but the device is configured so as to allow the technician (via interaction with the input interface of the device 16) to either accept the default value, or alternatively to adjust the default value to a new date/time. The BRT 28 saves technician-confirmed Off-Duty time-stamp. Once the technician goes off duty, the “LEAVE” menu option (see option #1 in FIG. 12) is replaced by a new option “On Duty”, which indicates, when selected, that the technician wishes to resume on-duty status. This change in the device display after “Going Off Duty” is shown in FIG. 15. Note that the off duty time is displayed in the “Working at:” menu. When the “On Duty” option is selected by the technician, a new screen is presented on the display device, as shown in FIG. 16. Again, the BRT 28 (or the wireless network or the hand-held device itself, for example) establishes a default value for the “On Duty” time as being equal to the current date and time, which can be either accepted or adjusted by the technician 14.

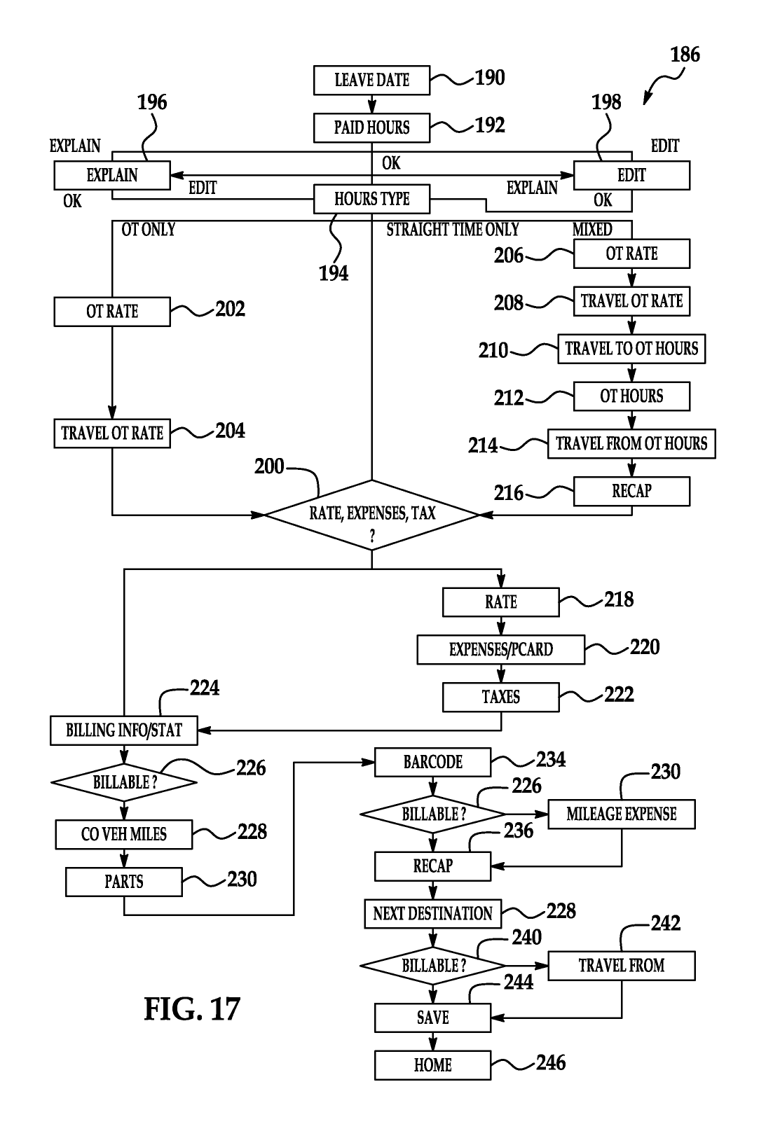

FIG. 17 is a flow chart diagram showing, in greater detail, a method for entering a time ticket that is shown in block form in FIG. 3 (block 186). Accordingly, the method of FIG. 17 (Time Ticket Entry) is performed after the technician has selected “LEAVE” on his hand-held device and after the DOW process (block 184, FIG. 3) has been completed.

The time ticket entry method begins in step 190, where device display presents a prompt for capturing a current work site “LEAVE” or departure time, which is illustrated in FIG. 18. The BRT module 28 establishes a default value for the “LEAVE” time (from the current work site) as being equal to the current date and time (although the default value may also be provided by the wireless provider network or the device 16 itself, for example). In any case, the default, current date/time is displayed on the device 16, but the device 16 is configured so as to allow the technician (via interaction with the input interface of the device 16) to either accept the default value, or alternatively to adjust the default value to a new date/time value. The method then proceeds to step 192.

In step 192, the device display shows the total paid hours, which is preferably calculated from the time-stamps accepted (or as adjusted) by the technician 14. The result is a “to the minute” sum of the various components constituting the paid time, namely, (1) paid travel-to time to the site; (2) paid on-site time (less any “off duty” time, as explained below); and (3) paid travel-from time. The hand-held device display may show, in one embodiment, a number of options, including “OK”, “Explain”, and “Edit”. If the technician selects “OK” then the method proceeds to “Hours Type” block 194 of FIG. 17, otherwise if the technician selects “Explain” then the method branches to explanation block 196, or alternatively if the technician selects “Edit” then the method branches to edit block 198.

The “explain” block 196 involves configuring the device display to show a textual description of how the BRT module 28 calculated the total paid hours. The device display may show an first option (“OK”) to allow the technician to accept the total paid hours calculation, in which case the method branches to the “Hours Type” block 194, or to alternatively accept a second option (“Edit”), in which case the method branches to the “Edit” block 198.

The time ticket edit block 198 allows the technician to adjust, for example, the “Arrive”, “Leave” or travel to time-stamps, thereby updating the time paid calculation. In the “Hours Type” block 194, the device display shows a prompt to capture a ticket type descriptor, which may include a number of options for selection by the technician, including a first option (“Straight Time Only”), in which case the method proceeds to block 200, a second option (“Overtime Only”), in which case the method branches to blocks 202 and 204, and a third option (“Mixed”), in which case the method proceeds to blocks 206 through 216.

The “Straight Time Only” option indicates that this type of time ticket includes only straight time. Likewise, the “Overtime Only” option indicates that this type of time ticket includes only overtime, and device display will show a prompt for the on-site overtime rate (block 202) and the travel time overtime rate (block 204). The method flows from block 204 to block 200.

The “Mixed” option indicates that this type of time ticket includes both regular time and overtime. The series of screen displays presented by the hand-held device will prompt the technician for several pieces of information, including (1) an on-site overtime rate (block 206); (2) a travel time overtime rate (block 208); (3) the amount of travel-to overtime hours (block 210); (4) the amount of on-site overtime hours (block 212); and (5) the amount of travel-from overtime hours. In hand-held device 16, as per block 216, shows a recap (i.e., summary screen) displaying the results of the information entered by the technician. The method flows from block 216 to block 200.

The block 200 provides a mechanism to vary and/or include additional cost items onto the time ticket or to alternatively skip directly to the next stage of the time ticket entry. In one embodiment, the block 200 involves the device display showing a number of options for selection by the technician, including a first option to vary and/or add components, in which case the method proceeds through blocks 218, 220 and 222, a second option to skip to the next stage, in which case the method branches to block 224.

In the rate block 218, the device display shows a prompt to allow the technician to override his regular rate and enter an alternative rate. In expense/Pcard block 220, the device display shows a prompt(s) to allow the technician to enter, for example, personal vehicle mileage dollars, expense card (“P Card) amounts incurred, or other (e.g., per diem) allowances that should be reflected on the time ticket. In the taxes block 222, the device display shows a prompt(s) to allow the service technician to enter state and/or city taxes. The method then flows from block 222 to block 224.

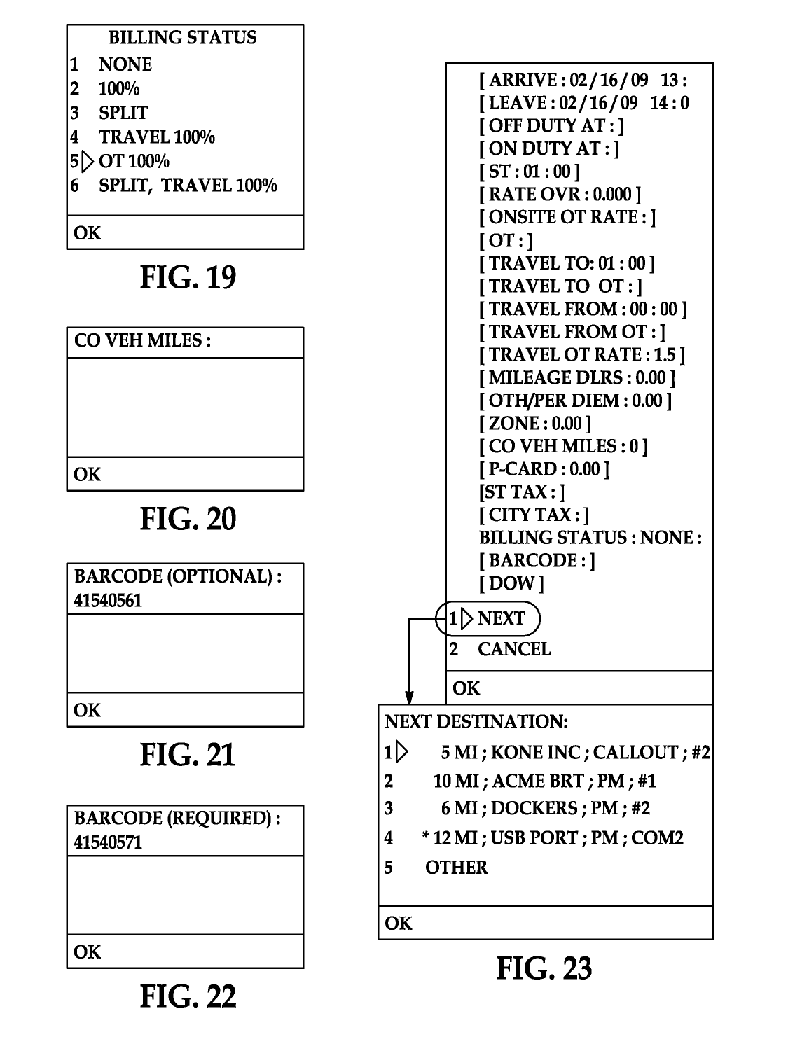

In block 224, the device display will show contract callback information, if the time under the subject time ticket was for a callout. Then, based on the Callout Coverage information provided in the previous screen, the device display will prompt the technician to select an appropriate billing status from a group that includes the following billing status identifiers: (1) “None”; (2) “100%”; (3) “Split”; (4) “Travel 100%”; (5) “OT 100%”; and (6) “Split, Travel 100%”, with a recommended billing status being designated (see below). This device display is shown in FIG. 19.

The system 12 is configured to present the different billing status options depending on one or more factors, including the contract coverage terms in light of the condition of the equipment upon arrival, the time of day (e.g., off-hours) or week (e.g., weekend) as well as other criteria as may be previously agreed upon between a customer and the service organization utilizing embodiments of the present invention. In effect, the system 12 will determine the recommended billing status, which will then be indicated on the device. In other words, the system-recommended selection for the billing status is the default selection on the device display (and which may be indicated, for example, by highlighting), but all the billing status options are both presented and are selectable by the technician. The technician can then confirm the recommended billing status (preferred) or select a different billing status.

In one embodiment, if the billing status selected by the technician is “100%” billable, the logic programmed in the system 12 (block 226) causes the device to display one or more further screens prompting for company vehicle miles (e.g., block 228 in FIG. 17 and also see FIG. 20) or a mileage expense (see blocks 226 and 230, FIG. 17). In a still further embodiment, if the billing status selected by the technician is either “100%” billable or “Split”, then the logic in the system 12 causes the device to display a screen (see block 232, FIG. 17) prompting for an identification of the parts used (e.g., “none”, “customer” part, “stock” part, “spare” part, “vendor” part, etc.). The method flows to block 234.

In block 234, the device display shows a prompt for a field service ticket barcode number. A physical (paper) field service ticket may optionally be completed by a service ticket and left behind at the customer work site, or in some circumstances, depending on the customer contract, a customer signature may be required, in which case a field service ticket must be completed in order to obtain the signature. In either case the logic programmed into the system 12 will prompt for optional entry (see FIG. 21) or required entry (see FIG. 22) of a barcode number corresponding to that on the completed, physical Field Service Ticket. The method then flows to a time ticket recap block 236.

FIG. 23 is a device display corresponding to the time ticket recap block 236, and summarizes the information after all the fields have been populated, either through automatic calculations or through information captured from the technician. The logic implemented by the BRT module 28 limits the kind of changes that the technician can make via the interface of the hand-held device to improve accuracy. For example, the technician's straight time entry cannot be adjusted directly, but rather would involve the technician changing at least one or more of the current work site arrival (“ARRIVE”) time, the departure (“LEAVE”) time, and any applicable “Going Off Duty” or “Going On Duty” times.

Referring to FIGS. 17 and 23, selecting “Next” from the time ticket recap screen opens the Next Destination view (block 238, FIG. 17; also FIG. 23). Here, the technician can select from the top five open service orders in the same manner as already described and illustrated above in connection with FIG. 5.

If the current service order that is being wrapped up is 100% billable (logic block 240, FIG. 17), and once the next destination (i.e., the successor work site associated with the next service order) is known, the BRT module 28 will prompt the technician to enter travel-from time, for example, by a message “All 100% billable work is portal to portal. Travel From (HH:MM)” (“Travel From” block 242, FIG. 17). The BRT module 28 will auto-populate this value with an estimated time of travel from the current work site location to the next, successor work site location using these two locations in conjunction with a mapping program (e.g., MapPoint). As above, the interface of the device 16 will allow the technician to either accept the suggested default value, or override it and adjust to a new travel from time. Finally, only after the next destination (service order) is selected will the time ticket for the current service order (work site) be saved (block 244, FIG. 17). The method flows from block 244 to block 246, where further processing occurs (e.g., the status of the next service order is “In transit to:” the next work site).

Calculation of Paid Hours (Block 54, FIG. 2). “Portal to portal” and other terms contained in service agreements between service organization and its customers can be efficiently provided for by embodiments of the system 12. Not only do the features described herein result in more accurate calculation of paid hours for the service technicians, but also results in more accurate invoices to customers. For example, for “portal to portal” calculations, the methodology involves determining a travel-to time indicative of the time spent by the technician travelling from a previous work site to the current work site. The travel-to time is calculated by the BRT module 28 using the previous-site departure (“LEAVE”) time and the current-site arrival (“ARRIVE”) time, both as captured by the wireless device. The method further involves determining the on-site time indicative of the time spent by the technician working at the current work site. The BRT module 28 uses the current-site arrival time (“ARRIVE”) and the current-site departure time (“LEAVE”), both as captured by the hand-held wireless device. In alternative embodiments, time spent “Off Duty” is subtracted from the on-site time. The method further involves selectively calculating a travel-from time for the technician to travel from the current work site to the next, successor work site, based on at least the respective locations of the current and next work sites. This step is selective in that not all time tickets will include a “travel from” time, but rather, for example, 100% billable service orders and overtime service orders where no next job exists. Finally, the BRT module 28 calculates the total chargeable time based on at least the travel-to time, the on-site time and the travel-from time. The system and method improves accuracy by defaulting to current time/date time-stamps, making accurate entry effortless. In addition, to account for the possibility of justified adjustments (e.g., when a technician takes non-paid lunch time during travel between sites), the system and method is configured to allow the technician to reject the default value, make adjustments and then accept the new time/date values, for example, an arrival time. Further flexibility is provided in the system, for example, to omit travel-to time in paid time calculations on the first service order of the day. Moreover, the system and method may selectively omit the travel-from time as well, for example, for service orders other than 100% billable service orders or on overtime service orders when no “next job” exists. To recap, the key pieces of information/screens include the captured “Leave” time from the previous work site (see FIG. 18 for “LEAVE” screen), the captured “Arrive” time at the current work site (see FIG. 7 for “ARRIVE” screen), a paid travel-to time confirmation screen (FIG. 8) and a travel-from time (see FIG. 23 for travel-from time in recap fashion).

Time Ticket Recap (Block 56, FIG. 2). By preventing direct editing of straight time, for example, accuracy is improved. The method provides that the technician can confirm the calculated hour amounts as shown in the recap, or may adjust the paid amount only by adjusting one or more of the current-site arrival time, the current-site departure time, the off-duty time and the on-duty time.

Mileage Entry (Expense) on 100% Billable Orders (Block 58, FIG. 2). The system improves capture of appropriate mileage expense on 100% billable service orders (i.e., the system enforces this through presentation of a prompt on the hand-held device display, as seen by reference to blocks 228 and 230 in flowchart of FIG. 17—Time Ticket Entry flowchart).

Assuming Callout Responsibility (Block 60, FIG. 2). The system provides improved flexibility and efficiency in providing a mechanism for a second technician to close out a service order that was accepted but then was interrupted by a first technician. The second technician can accept, using the hand-held device 16, responsibility for further work on the service and in closing out the interrupted service order. The second technician then becomes responsible for completing entry of the description of work (DOW—see block 184, FIG. 3), among other things.

Safety Locator. As described above, the safety locator module 32 is configured generally to obtain time-stamped location readings (at predetermined intervals) from each of the hand-held devices 16, each device 16 being associated with (registered to) a respective technician. The safety locator module 32 provides an interface for reviewing this data in real-time and is further configured to generate a deviation report detailing various location-based deviations, using the time-stamped location readings. Management personnel can use this interface for reviewing such data, and for reviewing the reports describing these deviations, which can be used as a tool to enforce compliance with policies of the organization as well as to improve quality/accuracy.

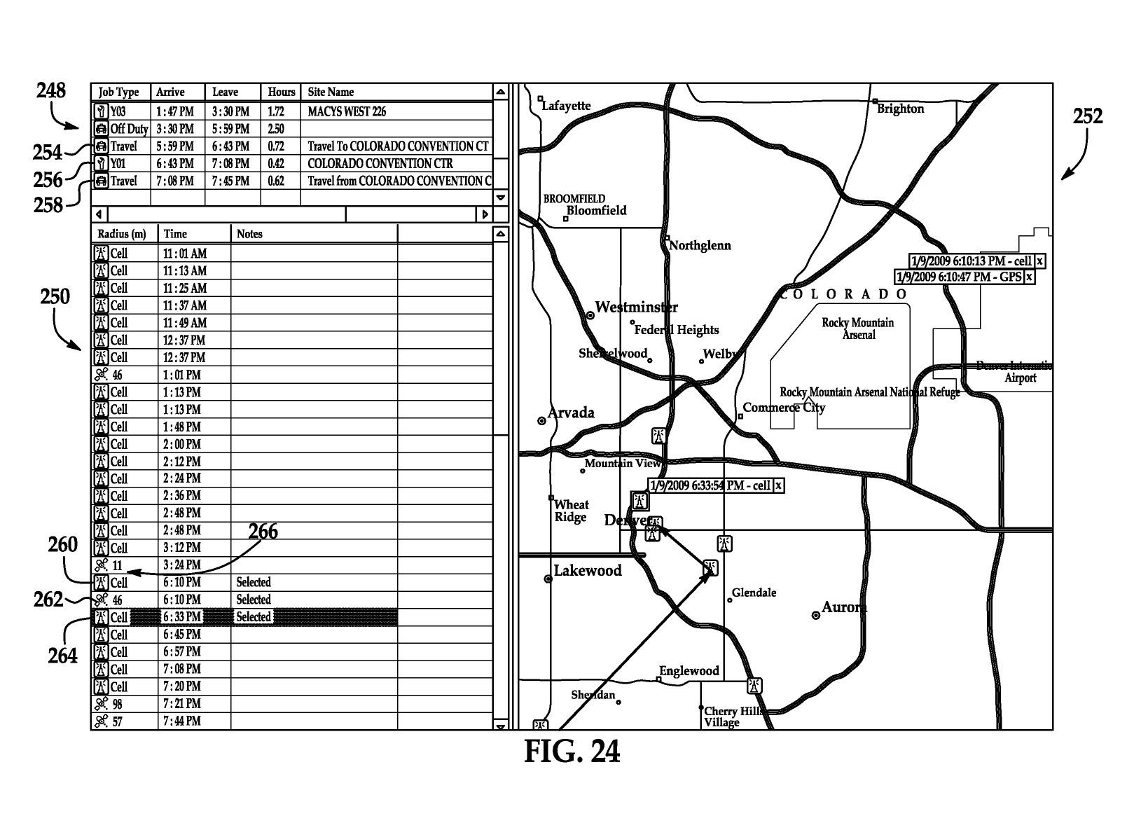

FIG. 24 is a screen display of an interface to the safety locator module 32. The interface includes a time-segment selector pane 248, a location data pane 250 and a map pane 252. The screen display of FIG. 24 reflects data for an individual technician. In the segment selector pane 248, several different time segments are listed, and can be selected by a user interacting with the safety locator module 32 through the interface. In particular, the interface in FIG. 24 allows the user to view a travel-to segment 254, an on-site segment 256, a travel-from segment 258 as well as off-duty segments for a particular technician. In the Figure, the travel-to segment 254 is selected, and the corresponding time-stamped location readings are selected, which are designated 260, 262 and 264 in the location data pane 250. These location readings 260, 262 and 264 are likewise shown in the keyed map in the map pane 252. Selecting another segment (e.g., the travel-from segment or the on-site segment) from the segment pane 248 will automatically select the corresponding location readings in the location data pane 250 (and indicate the selected readings on the keyed map in the map pane 252). Specific location readings can be manually selected from pane 250, which will be indicated on the map in the map pane 252.

Working At A Shop Instead of a Site (Safety Locator) (Block 62, FIG. 2). As described above, the BRT module 28 includes functionality that allows a technician to specify a secondary location (e.g., a shop) when working on a service order that has a different location as a primary work site (location). As described above, the safety locator module 32 is configured to generate a deviation report. In a prior system, the deviation of a technician working at a shop was determined relative to the primary work site location associated with the service order. When a technician worked at a secondary location, under the prior system, the data in the deviation report erroneously suggested that the technician was not at the work site. According to embodiments of the invention, the safety locator module 32 is configured to calculate a location deviation by comparing (1) the technician's time-stamped location readings with (2) the location of the secondary work site specified by the technician using the above functionality included in the BRT module 28. Under this approach, the deviation is measured relative to the secondary work site (i.e., shop) rather than the primary work site. This approach generates a deviation that accurately reflects the true state of affairs and avoids generating deviation data that can be misinterpreted as the technician not working at the designated work site.

Off-Duty Time During A Service Visit (Safety Locator) (Block 64, FIG. 2). As described above, the BRT module 28 provides functionality that allows a technician to go “Off Duty” while at a job site. The safety locator module 32 ordinarily is obtaining and recording a series of time-stamped location readings originating with the technician's device. However, when the technician selects to “Going off duty” that selection affects more than just time recording, but also affects the behavior of the safety locator module 32. Specifically, the safety locator module 32 is configured to create a separate entry (time segment) when the technician goes off duty, as described and illustrated in connection with FIG. 24. This entry in the segment pane 248 (FIG. 24) is visible in the safety locator interface. However, the safety locator module 32 is configured to suppress recording of the time-stamped location readings while the technician is “off duty”. For example, in FIG. 24, the technician is off duty between about 3:30 PM and 5:59 PM but there are no GPS or cell location readings/information during that off-duty time (see the arrow labeled 266, FIG. 24).

Verification of Travel Time (Safety Locator) (Block 66, FIG. 2). Another type of deviation or variance report generated by the safety locator module 32 relates to time worked or in travel, specifically broken down into total time, on-site time and travel time where total time is the sum of the travel time and the on-site time. Each of these time segments can be viewed individually. A prior system included the capability of verifying on-site using time-stamped location readings, but travel time for a technician was taken as entered by the technician. According to embodiments of the invention, the safety locator module 32 is configured to also produce a variation parameter as to travel time as well as on-site time.

The system 12 uses the mapping database 68 (FIG. 2) to obtain an estimated travel time between, for example, a previous work site and the current work site, which corresponds to the “travel-to” time described above. In one embodiment, the estimated travel time may be compared with the actual time (e.g., travel-to time in the example) to generate a deviation. In another embodiment, a predetermined buffer factor (e.g., 10%) is added to the estimated travel time from the mapping database 68 to account for travel variability. The same comparisons can be done for travel-from times submitted by technicians as well. Of course, on-site time can still be verified, using the known location of the work site along with the time-stamped location readings. In a still further embodiments, the payroll block 38 (FIG. 1) may be configured to calculate paid time based on the estimated travel time (as opposed to the actual travel time), or alternatively, the estimated travel time increased by some buffer factor (e.g., 10%) as described above. In the latter embodiments, the variation reports setting forth the variation in travel time can be used by the management of the service organization to assess job performance and/or detect conduct issues of the field technicians.

It is within the spirit and scope of the invention for various computational aspects of the system to occur on a distributed network, or occur on many computers within one network. In such a distributed scheme, various computational elements or routines may be executed locally on a computer or cellular phone within the possession of the technician while only high level information is transmitted back to the central office.

It should be further understood that the system 12, as described above may include conventional processing apparatus known in the art, capable of executing pre-programmed instructions stored in an associated memory, all performing in accordance with the functionality described herein. It is contemplated that the methods described herein, including without limitation the method steps of embodiments of the invention, will be programmed in a preferred embodiment, with the resulting software being stored in an associated memory and may also constitute the means for performing such methods. Implementation of the invention, in software, in view of the foregoing enabling description, would require no more than routine application of programming skills by one of ordinary skill in the art. Such a system may further be of the type having both ROM, RAM, a combination of non-volatile and volatile (modifiable) memory so that the software can be stored and yet allow storage and processing of dynamically produced data and/or signals.

What is claimed is:

1. A method for determining chargeable time relating to services performed by a service technician at a current work site, comprising the steps of:
(A) associating a hand-held wireless communication device with the service technician wherein the wireless device includes at least a display and an input interface;
(B) determining a travel-to time indicative of the time spent by the technician travelling from a previous work site to the current work site using a previous-site departure time and a current-site arrival time captured by the wireless device;
(C) determining an on-site time indicative of the time spent by the technician at the current work site using at least the current-site arrival time and a current-site departure time captured by the wireless device;
(D) selectively determining a travel-from time for the technician to travel from the current work site to a successor work site selected using the wireless device and based on at least the respective locations of the current and successor work sites; and
(E) determining chargeable time based on at least the travel-to time, the on-site time and the travel-from time.

2. The method of claim 1 wherein said associating step includes the sub-step of:
registering the association of the wireless device with the service technician on a central server using the wireless device.

3. The method of claim 1 wherein said step of determining the travel-to time includes the sub-steps of:
confirming through the wireless device the previous-site departure time and the current-site arrival time; and
defining the travel-to time as the difference between the confirmed current-site arrival time and confirmed previous-site departure time.

4. The method of claim 3 wherein said confirming sub-step includes:
accepting, through interaction with the input interface of the wireless device, default values for the previous-site departure time and the current-site arrival time.

5. The method of claim 3 wherein said confirming sub-step includes:
adjusting at least one default value for the previous-site departure time and the current-site arrival time; and
accepting, through interaction with the wireless device, the at least one adjusted default value.

6. The method of claim 1 wherein said step of determining the travel-to time is performed only when the current work site is associated with a service order that is other than the first service order of a calendar day.

7. The method of claim 1 wherein said step of determining the on-site time includes the sub-steps of:
confirming through the wireless device the current-site arrival time and the current-site departure time; and
determining the on-site time using at least the confirmed current-site arrival and departure times.

8. The method of claim 7 wherein said confirming sub-step includes:
accepting, through interaction with the input interface of the wireless device, default values for the current-site arrival time and the current-site departure time.

9. The method of claim 7 wherein said confirming sub-step includes:
adjusting at least one default value for the current-site arrival time and the current-site departure time; and
accepting, through interaction with the wireless device, the at least one adjusted default value.

10. The method of claim 1 wherein said step of selectively determining a travel-from time includes the sub-steps of:
providing a mapping database configured to provide at least a travel time between first and second locations;
defining the first and second locations using the respective locations of the current and successor work sites; and
obtaining an estimated travel-from time using the mapping database.

11. The method of claim 1 wherein the current work site is associated with a service order, said step of selectively determining a travel-from time being selectively performed when at least one of a plurality of conditions is satisfied wherein the conditions include the service order being a 100% billable service order and the service order being an overtime service order which is the last service order of a calendar day.

12. The method of claim 1 wherein the current work site is associated with a service order, said method further including the steps of:
displaying components of the paid time for the service order on the display of the hand-held device in a recap fashion wherein the components include at least the current-site arrival time, the current-site departure time, an off-duty time, an on-duty time, and the on-site time; and
configuring the interface of the device to allow alteration of the on-site time only through adjustment by the technician of one or more of the current site arrival time, the current site departure time, the off-duty time and the on-duty time.

13. The method of claim 12 wherein the on-site time comprises a straight-time component and an overtime component, wherein said configuring step further includes allowing alteration of the straight-time component only through adjustment by the technician of one or more of the current site arrival time, the current site departure time, the off-duty time and the on-duty time.

14. The method of claim 1 wherein the services performed by the technician at the current work site are associated with a service order, the method further comprising the step of:
setting a billing parameter when the service order constitutes a 100% billable order;
displaying, when the billing parameter is set, a message on the wireless device requesting the technician to enter mileage or mileage expense associated with the service order;
providing an mileage input field on the device configured to receive a mileage or mileage expense input; and
generating an invoice for the service order using at least the on-site time and the mileage input.

15. The method of claim 1 wherein said step of determining paid time includes the sub-steps of:
entering, using the wireless device, an off-duty time and an on-duty time where the off-duty time indicates the time when the technician went off-duty and the on-duty time indicates the time the technician resumed duty; and
adjusting the on-site time in accordance with the entered off-duty and on-duty times.

16. The method of claim 1 further including the steps of:
recording time-based location readings associated with and obtained using the wireless hand-held device after the technician arrives at the current work site;
receiving an off-duty indication through the device interface representative of the technician going off-duty and recording an off-duty time;
receiving an on-duty indication through the device interface representative of the technician resuming duty and recording an on-duty time;
suppressing the recording of the time-based location readings between the off-duty time and the on-duty time; and
validating the on-site time using at least (1) the current site arrival and departure times; (2) the off-duty and on-duty times, (3) the recorded time-based location readings, and (4) a work-site location associated with the current work site.

17. The method of claim 16 wherein said validating step includes the sub-steps of:
determining whether the recorded location readings correspond to the work-site location within a predetermined range.

18. The method of claim 1 further including the steps of:
selecting, through the device interface, a primary work site where the primary work site is associated with a service order;
after said selecting step, specifying, through the device interface, a secondary work site where the technician is to perform services associated with the service order;
recording time-based location readings associated with and obtained using the wireless hand-held device; and
determining a variance between the location readings and a secondary work-site location.

19. The method of claim 18 wherein said specifying step includes the sub-step of choosing a shop location.

20. The method of claim 18 further including the step of:
validating the on-site time at the secondary work site using at least (1) the arrival and work-site departure times for the secondary work site; (2) the determined variance.

21. The method of claim 1 further including the steps of:
recording time-based location readings associated with and obtained using the wireless hand-held device;
validating the travel-to time to the current work site using at least (1) the previous-site departure time and the current site arrival time; (2) the recorded time-based location readings, and (3) respective locations associated with the previous work site and the current work site.

22. The method of claim 1 further including the steps of:
recording time-based location readings associated with and obtained using the wireless hand-held device;
validating the travel-from time to the successor work site using at least (1) the current-site departure time and a successor-site arrival time; (2) the recorded time-based location readings, and (3) respective locations associated with the current work site and the successor work site.

23. A method for operating a service organization for rendering service at a work site, comprising the steps of:
(A) associating a first hand-held wireless communication device with a first service technician wherein the device includes a display and an input interface;
(B) accepting a callout to the work site by the first technician using the first device;
(C) after arriving at the work site, interrupting the callout through interaction with the input interface of the first wireless device;
(D) resuming the callout; and
(E) closing out the callout.

24. The method of claim 23 further including the step of associating a second hand-held wireless device with a second technician, wherein the step of resuming the callout includes the sub-step of accepting the callout by the second technician using the second wireless device.

25. The method of claim 24 wherein said step of closing out is performed through interaction with the input interface of the second wireless device.
